(19) United States
(12) Patent Application Publication
(10) Pub. No.: US 2018/0054535 A1
(43) Pub. Date: Feb. 22, 2018

(54) SYSTEM AND METHOD FOR ENHANCED DEVICE INTERFACE FOR SENIORS AND CHALLENGED USERS

(71) Applicants: Kabushiki Kaisha Toshiba, Minato-ku (JP); Toshiba TEC Kabushiki Kaisha, Shinagawa-ku (JP)

(72) Inventors: Jia Zhang, Irvine, CA (US); William Su, Riverside, CA (US)

(21) Appl. No.: 15/241,415

(22) Filed: Aug. 19, 2016

(51) Int. Cl. H04N 1/00; G06F 3/01; G06F 3/041; G09G 5/30

(52) U.S. Cl. CPC H04N 1/00514; H04N 1/00411; G06F 3/016; G06F 3/04842; G09G 5/30; H04N 2201/0094; G06F 2203/04105; G06F 3/0414

(57) ABSTRACT

A system and method for a customizable or adaptable user interface includes a touchscreen and a memory storing identification data corresponding to a device user. A processor generates a device interface screen on the display including a display of at least one user selectable, pressure sensitive area. The processor monitors input characteristic of a user selection during interaction with the pressure sensitive area and the memory stores a user interaction parameter corresponding to the device user in accordance with stored identification data. The processor adjusts an input parameter of the user selectable area in accordance with the input characteristic and the user interaction parameter. The processor then completes a document processing operation in accordance with instructions received from the user via interaction with the selectable area and an adjusted input characteristic.

### TECHNICAL FIELD

This application relates generally to adjustable or adaptable user interfaces for digital devices. The application relates more particularly to human operation of multifunction peripherals using an interface that is more conducive to people with special needs or challenges.

### BACKGROUND

Document processing devices include printers, copiers, scanners and e-mail gateways. More recently, devices employing two or more of these functions are found in office environments. These devices are referred to as multifunction peripherals (MFPs) or multifunction devices (MFDs). As used herein, MFPs are understood to comprise printers, alone or in combination with other of the afore-noted functions. It is further understood that any suitable document processing device can be used.

Given the expense in obtaining and maintain MFPs, devices are frequently shared or monitored by users or technicians via a data network. MFPs, while moveable, are generally maintained in a fixed location. A user may approach an MFP for purposes such as faxing from paper or electronic documents. Paper documents may be fed into a scanner for copying or faxing. Electronic documents may be on a portable data device, such as a CD, DVD or flash memory. Print outs may be made wirelessly from a portable digital device, such as a smartphone, tablet, or laptop computing device. Users may also send document processing jobs, such as a print request, to one or more networked devices. In a typical shared device setting, one or more workstations are connected via a network. When a user wants to print a document, an electronic copy of that document is sent to a document processing device via the network. The user may select a particular device when several are available. The user then walks to the selected device and picks up their job or waits for the printed document to be output. In these types of situations, users must still approach an MFP and control it directly.

MFP control is via a user interface, such as with switches, a keyboard, touchscreen, mouse, trackball or the like. Most, if not all, of standard user interface components are designed for the average or most common users. However, people have different physical characteristics that can make it more difficult, if not impossible, to use some or all of MFP capabilities.

### SUMMARY

In accordance with an example embodiment of the subject application, a system and method for a customizable or adaptable user interface includes a touchscreen and a memory storing identification data corresponding to a device user. A processor generates a device interface screen on the display including a display of at least one user selectable, pressure sensitive area. The processor monitors input characteristic of a user selection during interaction with the pressure sensitive area and the memory stores a user interaction parameter corresponding to the device user in accordance with stored identification data. The processor adjusts an input parameter of the user selectable area in accordance with the input characteristic and the user interaction parameter. The processor then completes a document processing operation in accordance with instructions received from the user via interaction with the selectable area and an adjusted input characteristic.

### BRIEF DESCRIPTION OF THE DRAWINGS

Various embodiments will become better understood with regard to the following description, appended claims and accompanying drawings wherein:

FIG. 1 an example embodiment of a multifunction processor with an adaptable or customizable interface;

FIG. 2 is an example embodiment of a document rendering system;

FIG. 3 is a software block diagram of an example embodiment of an adaptable or customizable user interface;

FIG. 4 is an example embodiment of an MFP interface;

FIG. 5 is an example embodiment of MFP keyboard adjustment;

FIG. 6 is an example embodiment of MFP keyboard adjustment;

FIG. 7 is an example embodiment of a MFP keyboard adjustment;

FIG. 8A is a side view of an example embodiment of a user interface

FIG. 8B is a top view of an example embodiment of a user interface;

FIG. 9 is an example embodiment of varied input forces;

FIG. 10 is an example embodiment of a touchscreen user interface; and

FIG. 11 is an example embodiment of altering keyboard timing.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

As noted above, MFP user interfaces are geared to more common users. Certain classes of users may have one or more physical challenges that make it difficult, frustrating or impossible to use an MFP productively. Challenges may be as straightforward as a user interface being out of reach. Examples may include people confined to wheelchairs or with dwarfism. While such may be addressed by aids such as ramps, raised seating or stepstools, many users have substantive physical challenges that are unaddressed.

Users with visual challenges may be unable to read interfaces with small fonts. Color blind users may not be able to distinguish between certain foreground and background color combinations, such as may be found on a display panel. Certain users may have involuntary movements, such as hand trembling or twitching. This may result in a user depressing a hard or soft key multiple times when only one depression is intended. Certain users may experience partial or complete loss of sight.

It may be impractical to design user interfaces for every type of challenged user, particularly since different users may have substantially different degrees of a similar challenge. For example, one user may need extreme magnification of control screens while another benefits from only slight magnification. Since less information or fewer controls can fit on a touchscreen display that has been magnified, having more magnification than needed can cause a user to be less efficient in operating an MFP.

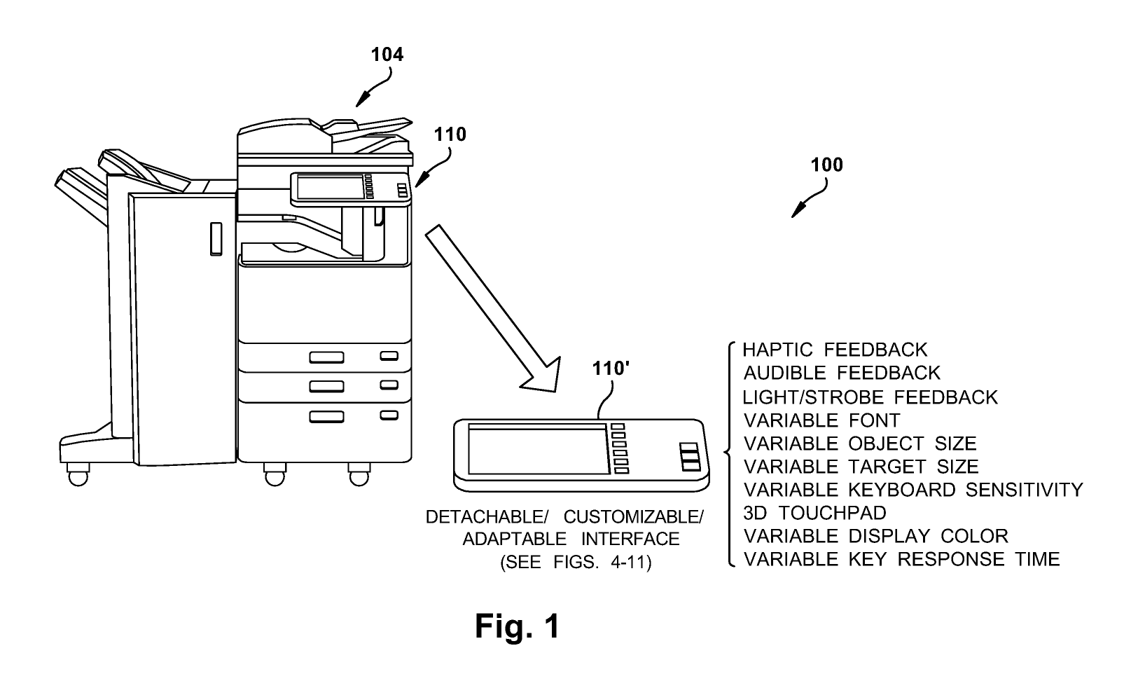

Referring to FIG. 1, illustrated is an example embodiment of a system 100 that addresses varying needs for different users as described above. While the example is directed to document processing devices, it will be appreciated that adaptive or customizable controls are suitably implemented in connection with any device control interface. Included with MFP 104 is a user interface 110, suitably comprised of a panel including a display, such as a touchscreen display, switches, trackball, mouse or any other suitable human/device interface. In the illustrated example, user interface is detachable as illustrated by 110′, and in data communication with the MFP via any suitable wireless or wired connection, including serialized data communications such as universal serial bus (USB), radio frequency connections such as WiFi, Bluetooth, near-filed communication (NFC), or optical connections such as infrared, ultraviolet, or optical spectrum light or laser. The removable user interface is suitably powered by a tether, battery or wireless power transfer. The removable user interface allows for easier interaction with shorter users or seated users, such as those in a wheelchair. The user interface may include one or more aspects of customizability, wherein modifications for one or more users are set by an administrator or by users themselves. The user interface may also be adaptable by monitoring user interaction and making adjustments accordingly. Depending on user need, modifications may include providing of haptic feedback, such as vibration to confirm an entry. This may be particularly advantageous when users are both visually and hearing impaired. Other feedback may include audible or indicator light or strobe feedback for visually impaired users. A variable font, such as enlarging a font, may be used for near-sighted users. A user selection target, such as a soft key or selector on a touchscreen display, may be used for visually impaired users or users with diminished motor skills who might find it difficult to direct their finger to a smaller target or object.

Variable keyboard or touchscreen sensitivity can be implemented so as to accommodate weaker or infirm users. Tactile feedback, such as with a three-dimensional touchscreen display, can advantageously be employed for blind or visually impaired users. Three dimensional touchscreens are programmable to have selected raised portions. These can be used to show selection areas or generate usable information, such as Braille letters.

Certain users may be prone to shaking or twitching, making it possible for them to mistakenly enter the same selection or keystroke multiple times. This may be addressed by modification in key response time, such as requiring a set delay before consecutive entries of the same key are registered. Display colors may also be altered to accommodate color blind users who may not be able to perceive certain foreground colors relative to certain background colors.

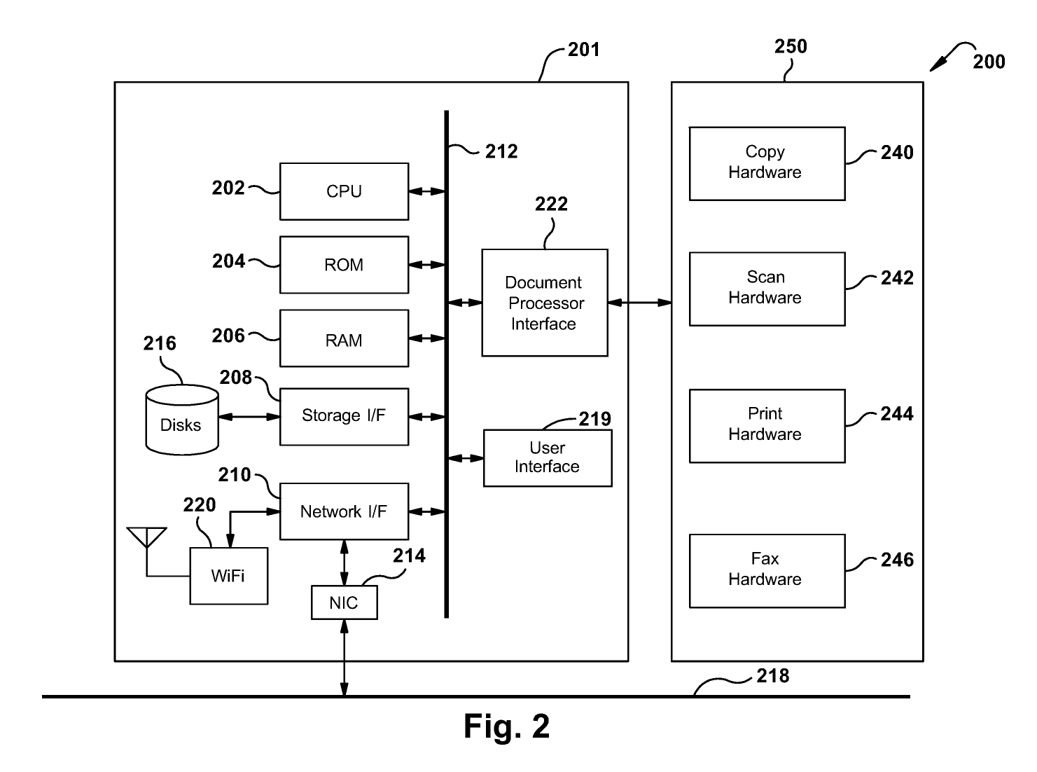

Turning now to FIG. 2, illustrated is an example embodiment of a document rendering system 200 suitably comprised within an MFP, such as with MFP 104 of FIG. 1. Included in controller 201 are one or more processors, such as that illustrated by processor 202. Each processor is suitably associated with non-volatile memory, such as ROM 204, and random access memory (RAM) 206, via a data bus 212. Processor 202 is also in data communication with a storage interface 208 for reading or writing to a storage 216, suitably comprised of a hard disk, optical disk, solid-state disk, cloud-based storage, or any other suitable data storage as will be appreciated by one of ordinary skill in the art.

Processor 202 is also in data communication with a network interface 210 which provides an interface to a network interface controller (NIC) 214, which in turn provides a data path to any suitable wired or physical network connection 218 or to a wireless data connection via wireless network interface 220. Example wireless connections include cellular, Wi-Fi, BLUETOOTH, NFC, wireless universal serial bus (wireless USB), satellite, and the like. Example wired interfaces include Ethernet, USB, IEEE 1394 (FireWire), LIGHTNING, telephone line, or the like.

Processor 202 can also be in data communication with any suitable user input/output (I/O) interface 219 which provides data communication with user peripherals, such as displays, keyboards, mice, track balls, touchscreens, or the like. Also in data communication with data bus 212 is a document processor interface 222 suitable for data communication with MFP functional units 250. In the illustrate example, these units include copy hardware 240, scan hardware 242, print hardware 244 and fax hardware 246 which together comprise MFP functional hardware 250. It will be understood that functional units are suitably comprised of intelligent units, including any suitable hardware or software platform.

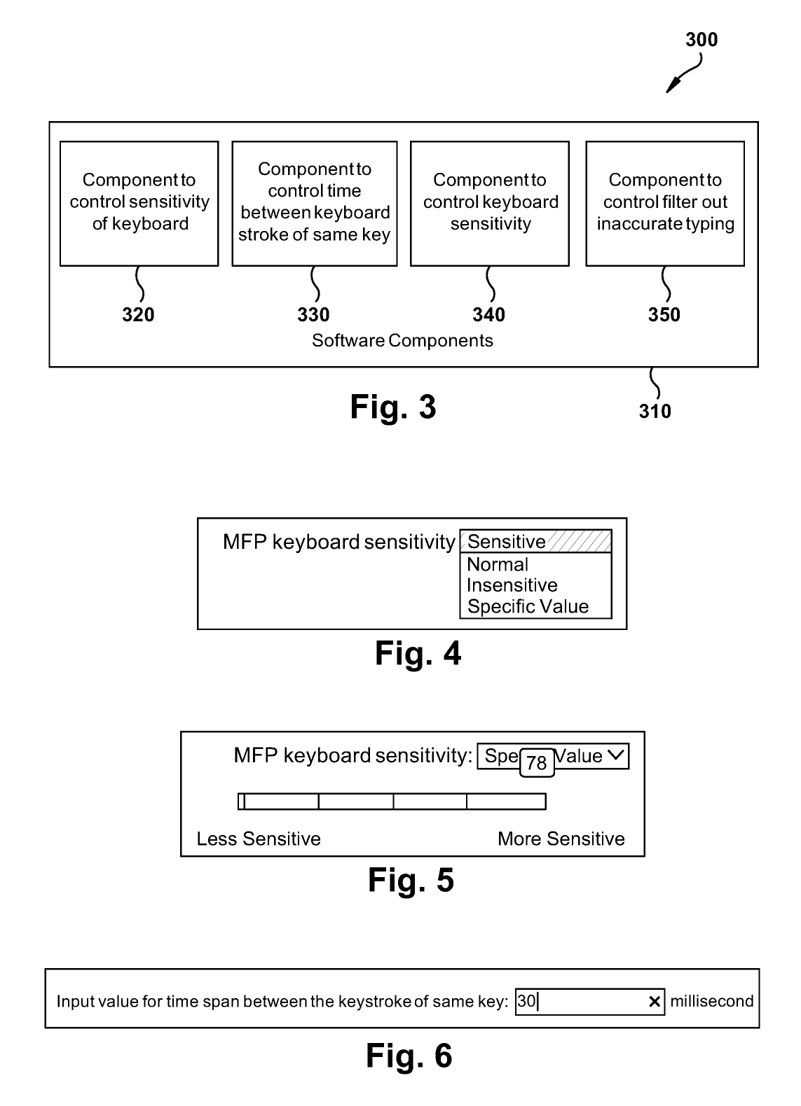

Turning now to FIG. 3, illustrated is a software block diagram 300 for operation of an embodiment of an adaptable or customizable user interface as described herein. Software component 310 suitably includes a module 320 for determining input sensitivity, such as for depressing switches, keys or a touchscreen. Module 330 provides for input of timing between key depressions of the same key or touchscreen selection. Module 340 controls keyboard, switch or touchscreen sensitivity. Module 350 provides for filtering input errors, including correction of inaccurate typing.

Turning next to FIGS. 4-6, illustrated is are example embodiments of user interfaces that are customizable for one or more users by an administrator or by users themselves. FIG. 4 illustrates MFP keyboard or touchscreen sensitivity selection via a dropdown menu. FIG. 5 illustrates adjustment of MFP keyboard or touchscreen sensitivity by a slider bar when a SPECIAL VALUE selection is chosen from the drop down menu of FIG. 4. FIG. 6 illustrates a selector for a duration defining when consecutive presses of the same key or selection will be recognized.

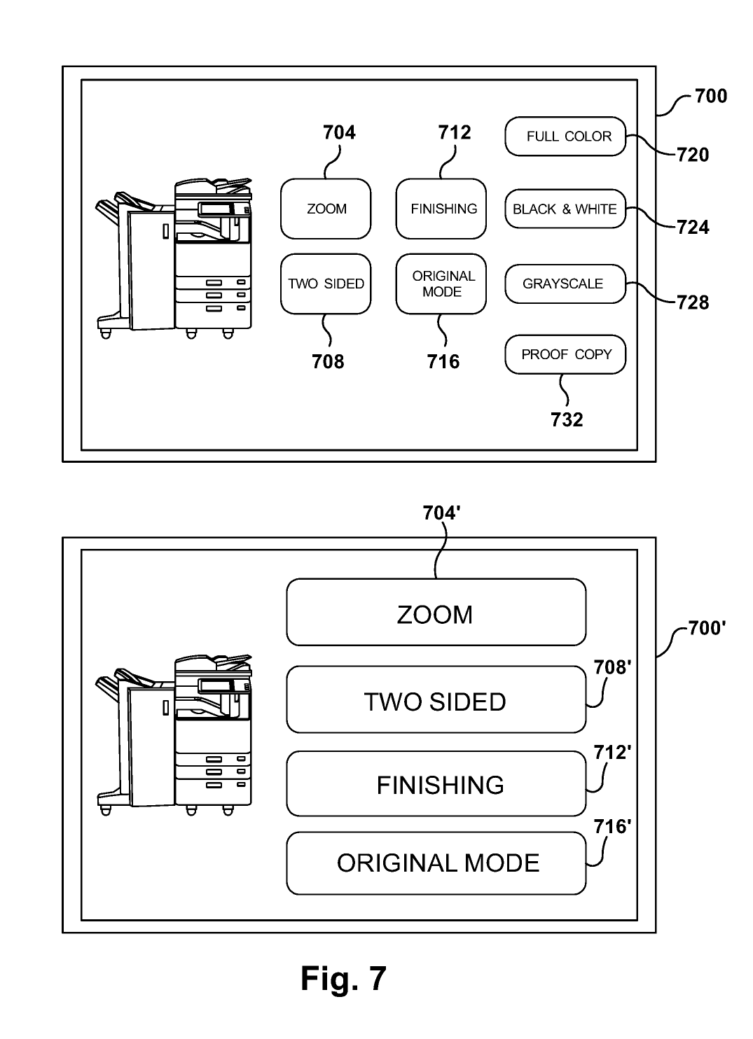

Referring now to FIG. 7, illustrated is an example embodiment of MFP touchscreen control panel 700 that includes MFP document processing selections, having selectable target areas including zoom 704, two-sided output 708, finishing options 712 and original mode selection 716. Also included are selectable areas for full color printing 720, black and white printing 724, grayscale printing 728 and generation of a proof copy 732. A modified touchscreen control panel 700′ has target areas enlarged, including zoom 704′, two-sided 708, finishing 712′ and original mode 716′ which are counterparts to the control areas of screen 700. The target areas have been enlarged to accommodate users. In this instance, there is a tradeoff in available selections given the additional use of display space.

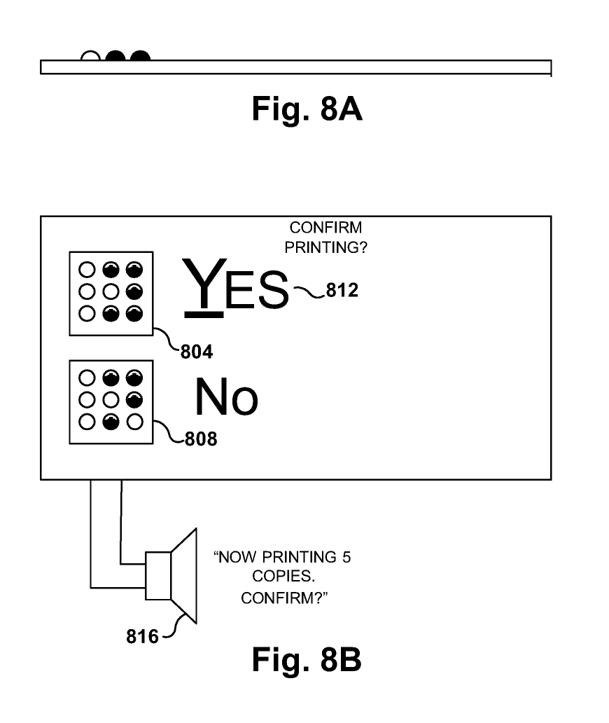

FIG. 8 includes a side view (a) and a top view (b) of an example embodiment of a user interface comprising a three dimensional touchscreen, such as an LCD or OLED touchscreen that has a surface that can be selectively extended above the plane of the display panel. In the example embodiment, portions areas 804 and 808 have been selectively controlled so as to display Braille characters for responding to a yes or no confirmation to complete a print operation. A Braille letter Y is generated in area 804 and a Braille letter N is generated in area 808. A visually challenged user can determine the letter and make their selection accordingly by depressing the corresponding Braille area. Visible characters are also suitably rendered, such as in a large font in the event that the user possesses limited vision. Visual selection may be confirmed such as by highlighting or underlining, both of which are present in the letter Y in YES selection 812. Audible prompting may also be generated, such as via speaker 816.

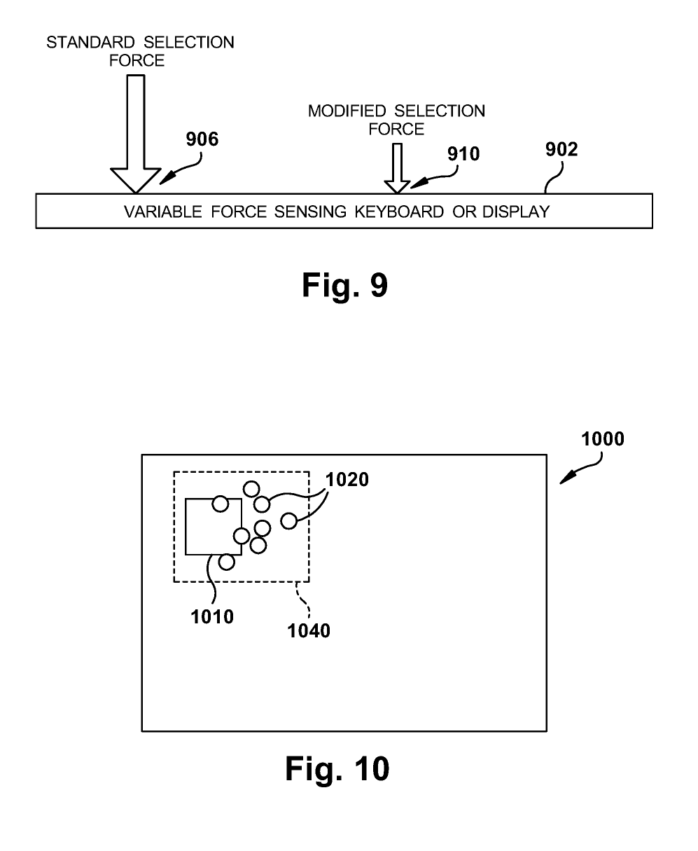

FIG. 9 illustrates an example embodiment of varied forces that may be selected or set on a key, keyboard or force sensing touchscreen such as illustrated by surface 902. One or more selections may default to or be set to a higher force level, such as area 906 while one or more selections may be set to a lower force level such as area 910.

FIG. 10 illustrates an example embodiment of a touchscreen user interface 1000 that includes a software settable selectable contact area 1010. Areas 1020 may indicate touches by a user as they try to hit contact area 1010. Touches outside of area 1010 indicate that the user may have an impairment that prevents them for accurately hitting the target sized at area 1010. The MFP processor suitably calculates an extended range by the user's selections, and may generate an enlarged target area 1040. Enlarged area 1040 may be a default, larger size, or may be enlarged to accommodate the user's prior attempts. The settings may be captured for the user and stored for future reference, and may be applied to other target areas for other user selections.

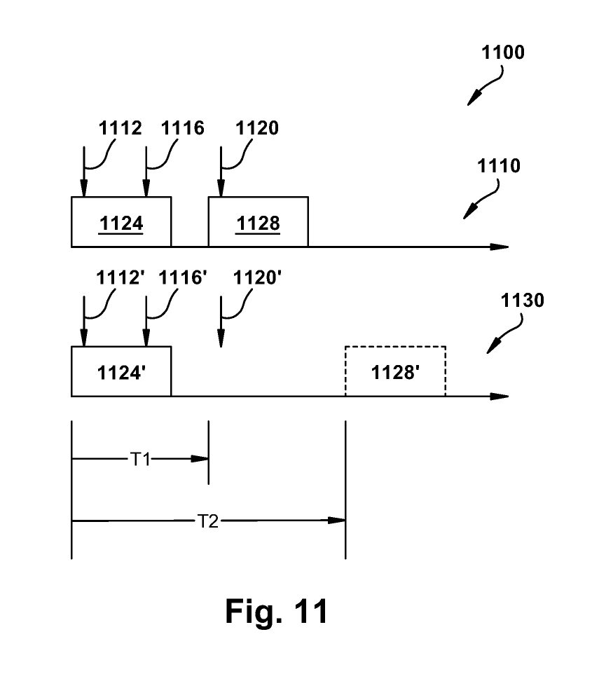

FIG. 11 illustrates an example embodiment of varying delay periods 1100 for recognition of successive depressions of the same key or area. Timeline 1110 shows how three rapidly successive pushes 1112, 1116 and 1120 can result in two selections when successive entries 1124 and 1128 are taken with a delay period of T1 recognized between command acceptances. Timeline 1130 shows an adjustment of the key acceptance delay to T2. It will be seen that with this adjustment, corresponding keystrokes 1112′, 1116′ and 1120′ are analogous to the earlier keystrokes relative to timing, but in this instance, the added delay results in no second activation of the same key at 1128′.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

What is claimed is:

1. A system comprising:
a user interface including a pressure sensitive input;
a memory configured to
store identification data corresponding to a device user, and
store a user interaction parameter corresponding to the device user in accordance with stored identification data; and
a processor configured to
generate a device interface screen on a display
monitor input characteristic of a user selection during interaction with the pressure sensitive input,
adjust an input parameter of the pressure sensitive input in accordance with the input characteristic and the user interaction parameter, and
complete a document processing operation in accordance with instructions received from the user via interaction with the pressure sensitive input and an adjusted input characteristic.

2. The system of claim 1 wherein the processor is further configured to monitor the input characteristic comprised of a pressure level of the user selection, and wherein the user interaction parameter is comprised of a pressure setting associated with the user.

3. The system of claim 1 wherein the processor is further configured to monitor the input characteristic comprised of a series of selections during a selected duration, and wherein the user interaction parameter is comprised of duration setting associated with the user and the pressure sensitive input.

4. The system of claim 1 wherein the user interaction parameter defines a projection level of at least a portion of the pressure sensitive input from a surface of a touchscreen.

5. The system of claim 4 wherein the user interaction parameter defines at least one Braille indicator on the surface of the touchscreen.

6. The system of claim 1 wherein the processor generates the user interaction parameter to adjust a size of the pressure sensitive input comprised of a pressure sensitive area on a touchscreen.

7. The system of claim 1 wherein the processor generates the user interaction parameter as haptic feedback on the pressure sensitive input.

8. A method comprising:
generating a device control display area on a touchscreen;
receiving pressure level data corresponding to user pressure applied on the touchscreen in accordance with the control display;
adjusting a parameter of the control display in accordance with pressure level data;
receiving user selection data from an adjusted control display; and
completing a document processing operation in accordance with received user selection data.

9. The method of claim 8 wherein adjusting the parameter of the control display includes resizing the display area.

10. The method of claim 9 wherein resizing the display area includes resizing a font size of text displayed on the touchscreen.

11. The method of claim 8 wherein the pressure level data includes data from pressure applied within the display area and outside of the display area.

12. The method of claim 8 wherein adjusting the parameter of the control display includes adjusting a pressure sensitivity of the display area.

13. The method of claim 8 wherein adjusting the parameter of the control display includes generating haptic feedback on the display area.

14. The method of claim 8 further comprising generating a confirmation prompt to the user after receiving the user selection data from the adjusted control display.

15. The method of claim 8 wherein the confirmation prompt is comprised of an audible or visual indicator.

16. A document processing device including:
a device controller including a processor and memory;
a touch sensitive display;
wherein the processor is configured to generate a device control screen having at least one user selectable area on the touch sensitive display;
wherein the processor is further configured to receive display control parameter data corresponding to a device user;
wherein the processor is further configured to adjust a property of the device control screen in accordance with received display control parameter data;
wherein the processor is further configured to receive a control selection from an associated user via an adjusted user selectable area of control screen; and
wherein the processor is further configured to commence a document processing operation in accordance with a received control selection.

17. The device of claim 16 wherein the processor is further configured to receive the display control parameter data indicative of a selected pressure corresponding to input from the adjusted user selectable area.

18. The device of claim 16 wherein the processor is further configured to receive the display control parameter indicative of a selected duration of pressure corresponding to input from the user selectable area.

19. The device of claim 16 wherein the processor is further configured to receive the display control parameter data comprised of a display color selection.

20. The device of claim 16 wherein the processor is further configured to receive the display control parameter data comprised of three dimensional Braille output generation data.
